(19) United States
(12) Patent Application Publication
(10) Pub. No.: US 2025/0254074 A1
(43) Pub. Date: Aug. 7, 2025

(54) SIGNAL TRANSMISSION METHOD BASED ON RANDOM UNITARY CODING MODULATION AND CROSS-DOMAIN ITERATIVE DETECTION

(71) Applicant: Zhejiang University, Hangzhou City (CN)

(72) Inventors: Lei Liu, Hangzhou City (CN); Yuhao Chi, Hangzhou City (CN); Xuehui Chen, Hangzhou City (CN); Ying Li, Hangzhou City (CN); Zhaoyang Zhang, Hangzhou City (CN)

(21) Appl. No.: 19/042,176

(22) Filed: Jan. 31, 2025

(30) Foreign Application Priority Data
Feb. 4, 2024 (CN) 202410156751.6

(51) Int. Cl. H04L 27/26; H04L 1/00

(52) U.S. Cl. CPC H04L 27/2607; H04L 1/005; H04L 27/2627

(57) ABSTRACT

The present application provides a signal transmission method based on random unitary coding modulation and cross-domain iterative detection, including random unitary coding modulation at a signal transmitting end and cross-domain iterative detection at a receiving end. The random unitary coding modulation includes random unitary modulation or random unitary precoding, utilizing random unitary transformations to ensure that an equivalent channel matrix satisfies the correct right unitary invariance assumption. The cross-domain iterative detection includes using a cross-domain iterative receiver to receive a signal obtained after the random unitary coding modulation. The random unitary coding modulation ensures that general OAMP/VAMP, UAMP, and MAMP-type receivers achieve Bayesian optimal performance. The cross-domain iterative detection allows, through cross-domain detection, the receiver to utilize ultra-sparse time-domain channels, including low-complexity MAMP, OAMP/VAMP, and UAMP-type receivers.

### CROSS REFERENCE TO RELATED APPLICATION

This patent application claims the benefit and priority of Chinese Patent Application No. 2024101567516, filed with the China National Intellectual Property Administration on Feb. 4, 2024, the disclosure of which is incorporated by reference herein in its entirety as part of the present application.

### TECHNICAL FIELD

The present disclosure relates to the field of signal transmission, and in particular, to a signal transmission method based on random unitary coding modulation and cross-domain iterative detection.

### BACKGROUND

With the rapid development of wireless communication technologies, the communication demands in high mobility scenarios, such as high-speed railway systems and low Earth orbit satellites, have been increasing. However, the Doppler shift caused by high-speed movement can lead to severe inter-carrier interference, disrupting the orthogonality of subcarriers in orthogonal frequency division multiplexing (OFDM), making it difficult for OFDM to ensure reliable data transmission.

To mitigate the impact of Doppler shift, orthogonal time frequency space (OTFS) has been proposed, which multiplexes information symbols in the delay-Doppler (DD) domain, achieving diversity in both channel delay and Doppler shift, thus improving the reliability of signal transmission. Recently, affine frequency division multiplexing (AFDM) has been introduced, employing the inverse discrete affine Fourier transform (IDAFT) to modulate information symbols into the time-frequency domain. Through this approach, AFDM has been proven to achieve full diversity in high mobility communication systems.

The significant potential diversity gain of OTFS and AFDM can only be realized using high-complexity maximum likelihood (ML) receivers, which severely limits the practical application. Currently, many studies on low-complexity receivers for OTFS have been proposed. In the prior art, a cross domain orthogonal approximate message passing (CD-OAMP) receiver has been introduced, in which the estimated signal is iteratively transmitted between the time domain and the DD domain. Additionally, a DD-OAMP receiver has been proposed for signal detection in the DD domain. However, because CD/DD-OAMP employs linear minimum mean square error (LMMSE) estimation, the sparsity of the channel matrix is not fully exploited for matrix inversion, resulting in high complexity. To address this issue, the prior art proposes a delay-Doppler domain memory approximate message passing (DD-MAMP) receiver, which uses a memory matched filter (MF) to exploit the sparsity of the DD domain channel matrix. However, DD-MAMP neglects the even sparser time domain channel matrix. For AFDM, the development of receivers remains in the early stage, and no efficient design has yet been proposed to fully exploit the significant diversity gain of AFDM.

The main idea behind existing multi-carrier modulation techniques (such as OFDM, OTFS, and AFDM) is to minimize inter-symbol interference to obtain an equivalent sparse channel matrix. This enables the use of a simplified low-complexity receiver for signal recovery. However, each signal only experiences limited channel fading, which leads to degraded detection performance of existing multi-carrier modulation techniques (such as OFDM, OTFS, and AFDM) in practical receivers.

### SUMMARY

The present disclosure aims to provide a signal transmission method based on random unitary coding modulation and cross-domain iterative detection in view of the shortcomings of the prior art.

The purpose of the present disclosure is realized by the following technical solutions: A signal transmission method based on random unitary coding modulation and cross-domain iterative detection includes random unitary coding modulation at a signal transmitting end and cross-domain iterative detection at a receiving end;

the random unitary coding modulation is achieved through random unitary modulation or random unitary precoding;

the random unitary modulation includes: performing digital modulation on an information bit sequence at a transmitter, performing serial-to-parallel (S/P) conversion on modulated information and performing the random unitary modulation on the modulated information through a random unitary transformation matrix, adding a cyclic prefix (CP) to a signal vector after the random unitary modulation, and transmitting the signal vector to a channel after passing through a transmit filter;

the random unitary precoding includes: performing channel coding and digital modulation on an information bit sequence at a transmitter, performing unitary precoding on modulated information through a random unitary transformation matrix to obtain a new symbol sequence, and combining the new symbol sequence with an existing transmission scheme to obtain a transmission signal for transmission; and

the cross-domain iterative detection includes using a cross-domain iterative receiver to receive the signal obtained after the random unitary coding modulation.

Further, the random unitary transformation matrix in the random unitary modulation is a unitary invariant matrix.

Further, a process of using the cross-domain iterative receiver is specifically as follows: based on a received signal y and priori estimation xₜ obtained through nonlinear detection, performing linear detection to output an estimated signal rₜ, performing inverse random unitary transformation to obtain a signal \tilde{r}ₜ, further, performing nonlinear detection to obtain an output estimated signal sₜ₊₁, performing random unitary transformation to generate xₜ₊₁ and input xₜ₊₁ into linear detection; conducting iteration until the estimated signal sₜ₊₁ is accurately recovered or a preset maximum iteration count is reached, ending the entire detection process, and outputting a final estimated signal as the received signal.

Further, the cross-domain iterative receiver is a Bayesian optimal cross-domain iterative receiver, and the Bayesian optimal cross-domain iterative receiver specifically multiplies a sparse time-domain channel matrix with an input signal using a time-domain memory MF in the linear detection of the cross-domain iterative receiver, and performs orthogonal minimum mean square error (MMSE) demodulation in the nonlinear detection.

Further, processing of the random unitary modulation at the transmitting end in a multiple-input multiple-output (MIMO) scenario includes: performing signal segmentation after the random unitary modulation or performing signal segmentation before the random unitary modulation; and said performing signal segmentation before the random unitary modulation further includes performing the segmentation using a random permutation matrix before the random unitary modulation; and
corresponding processing at the receiving end includes: separately receiving signals through receive filters on antennas of the receiving end, removing CPs, and performing signal merging; After merging, using the cross-domain iterative receiver to receive the signal obtained after the random unitary coding modulation.

Further, said performing signal segmentation after the random unitary modulation specifically includes:
Segmenting a digital modulation signal into a plurality of segments after the S/P conversion and the random unitary modulation, adding a CP to each segment, obtaining a time-domain signal through a transmit filter, and transmitting the time-domain signal to the channel through the antenna; and
Corresponding processing by the cross-domain iterative receiver is as follows: based on a received signal y and priori estimation xₜ obtained through nonlinear detection, performing linear detection to output an estimated signal rₜ, performing inverse random unitary transformation to obtain a signal \tilde{r}ₜ, further, performing nonlinear detection to obtain an output estimated signal sₜ₊₁, performing random unitary transformation to generate xₜ₊₁ and input xₜ₊₁ into linear detection; conducting iteration until the estimated signal sₜ₊₁ is accurately recovered or a preset maximum iteration count is reached, ending the entire detection process, and outputting a final estimated signal as the received signal.

Further, said performing signal segmentation before the random unitary modulation specifically includes:
Segmenting a digital modulation signal into a plurality of segments after the S/P conversion, performing random unitary modulation on each segment and adding a CP to each segment, obtaining a time-domain signal through a transmit filter, and transmitting the time-domain signal to the channel through the antenna; and
Corresponding processing at the receiving end is as follows: separately receiving signals through receive filters on antennas of the receiving end, removing CPs, and performing signal merging; after merging, using the cross-domain iterative receiver to receive the signal obtained after the random unitary coding modulation, where implementation steps of the cross-domain iterative receiver include: segmenting an estimated signal rₜ output from linear detection into Nₜ segments, performing inverse random unitary modulation on each segment, merging the segments to obtain an estimated signal \tilde{r}ₜ, and inputting the estimated signal \tilde{r}ₜ into nonlinear detection; segmenting an estimated signal sₜ₊₁ output from nonlinear detection into Nₜ segments, performing random unitary modulation on each segment, merging the segments to obtain an estimated signal xₜ₊₁, and inputting the estimated signal xₜ₊₁ into linear detection; conducting iteration until the estimated signal sₜ₊₁ is accurately recovered or a preset maximum iteration count is reached, ending the entire detection process, and outputting a final estimated signal as the received signal.

Further, said performing the segmentation using a random permutation matrix before the random unitary modulation specifically includes:
Segmenting a digital modulation signal into a plurality of segments after the S/P conversion and the random permutation matrix, performing random unitary modulation on each segment and adding a CP to each segment, obtaining a time-domain signal through a transmit filter, and transmitting the time-domain signal to the channel through the antenna; and
Corresponding processing at the receiving end is as follows: separately receiving signals through receive filters on antennas of the receiving end, removing CPs, and performing signal merging; after merging, using the cross-domain iterative receiver to receive the signal obtained after the random unitary coding modulation, where implementation steps of the cross-domain iterative receiver include: segmenting an estimated signal rₜ output from linear detection into Nₜ segments, performing inverse random unitary modulation on each segment, merging the segments and inputting into the random permutation inverse matrix Π^{H} to obtain an estimated signal \tilde{r}ₜ, and inputting the estimated signal \tilde{r}ₜ into nonlinear detection; segmenting an estimated signal sₜ₊₁ output from nonlinear detection into Nₜ segments, inputting the segments into the random permutation matrix Π and segmenting into Nₜ segments, performing random unitary modulation on each segment, merging the segments to obtain an estimated signal xₜ₊₁, and inputting the estimated signal xₜ₊₁ into linear detection; conducting iteration until the estimated signal sₜ₊₁ is accurately recovered or a preset maximum iteration count is reached, ending the entire detection process, and outputting a final estimated signal as the received signal.

Further, the random unitary coding modulation using the random unitary precoding specifically includes:
Performing channel coding on the information bit sequence to generate a sequence c, mapping the sequence C into a symbol sequence s through digital modulation, precoding s using a random unitary matrix U to obtain a new symbol sequence b, that is, b=Us, generating a transmission sequence x using the existing transmission scheme P, where x=Pb=PUs, and transmitting the sequence x to the channel, where the signal y received at the receiving end is denoted as:

$$y = Hx + w = HPUs + w = {H}_{eff} s + w .$$

H_{eff}=HPU, H is a time-domain channel matrix, H_{eff} is a transform domain equivalent channel, and w˜CN(0,≐²I) is an additive Gaussian white noise.

The present disclosure has following beneficial effects:
The present disclosure provides a random unitary coding modulation technology, including random unitary matrix modulation and random unitary precoding, to ensure high-reliability signal transmission in communication systems with static multipath and dynamic time-varying conditions. Unlike existing multicarrier modulation techniques (such as OFDM, OTFS, and AFDM), the random unitary modulation achieves non-orthogonal transmission. By utilizing random unitary transformations, all signals are randomly superimposed, such that each signal undergoes statistically stationary channel fading, ensuring the achievement of maximum diversity gain. In addition, the random unitary transformations enable the equivalent channel matrix to satisfy the standard right unitary invariance assumption, ensuring that general orthogonal/vector AMP (OAMP/VAMP), unitary AMP (UAMP), and memory AMP (MAMP)-type receivers achieve Bayesian optimal performance.

The random unitary precoding can be directly applied to communication systems represented by standard linear models, such as OFDM, OTFS, AFDM, and reconfigurable intelligent surface (RIS), such that the equivalent channel matrix satisfies the standard right unitary invariance assumption. This, in turn, enables general OAMP/VAMP, UAMP, and MAMP-type receivers to achieve Bayesian optimal performance.

However, the equivalent channel of random unitary modulation is fully dense, presenting a significant challenge for signal detection. To address this issue, the present disclosure leverages the characteristics of random unitary transformations. By using linear detection in the time domain, the receiver can exploit the sparsity of the time-domain channel, thereby achieving low-complexity signal detection.

### BRIEF DESCRIPTION OF THE DRAWINGS

FIG. 1 is a flowchart of a signal transmission method based on random unitary coding modulation and cross-domain iterative detection;

FIGS. 2A-2B show comparison between a time-domain channel and a transform domain equivalent channel according to an embodiment of the present disclosure;

FIG. 3 is a flowchart of a signal transmission method of a random unitary modulation scheme 1 in a MIMO scenario according to an embodiment of the present disclosure;

FIG. 4 is a flowchart of a signal transmission method of a random unitary modulation scheme 2 in a MIMO scenario according to an embodiment of the present disclosure;

FIG. 5 is a flowchart of a signal transmission method of a random unitary modulation scheme 3 in a MIMO scenario according to an embodiment of the present disclosure;

FIG. 6 is a flowchart of a signal transmission method based on random unitary precoding according to an embodiment of the present disclosure;

FIGS. 7A-7B are comparison diagrams of an estimated signal before and after random unitary transformation according to an embodiment of the present disclosure;

FIG. 8 is a schematic diagram of a cross-domain MAMP receiver according to an embodiment of the present disclosure;

FIG. 9 is a bit error rate (BER) comparison diagram of interleave frequency division multiplexing (IFDM), OFDM, OTFS, and AFDM in a single-input single-output (SISO) scenario when the speed of a mobile station is 300 km/h according to an embodiment of the present disclosure;

FIG. 10 is a BER comparison diagram of IFDM, OFDM, OTFS, and AFDM in a 4*4 MIMO scenario when the speed of a mobile station is 300 km/h according to an embodiment of the present disclosure;

FIG. 11 is a BER comparison diagram of IFDM, OFDM, OTFS, and AFDM in a SISO scenario when the speed of a mobile station is 500 km/h according to an embodiment of the present disclosure; and

FIG. 12 is a comparison diagram of MAMP and OAMP runtime in different modulation schemes in a MIMO scenario according to an embodiment of the present disclosure.

### DETAILED DESCRIPTION OF THE EMBODIMENTS

The specific implementations of the present disclosure are described in further detail below with reference to the accompanying drawings.

The present disclosure provides a signal transmission method based on random unitary coding modulation and cross-domain iterative detection. The method includes random unitary coding modulation at a signal transmitting end and cross-domain iterative detection at a receiving end.

The random unitary coding modulation is achieved through random unitary modulation or random unitary precoding.

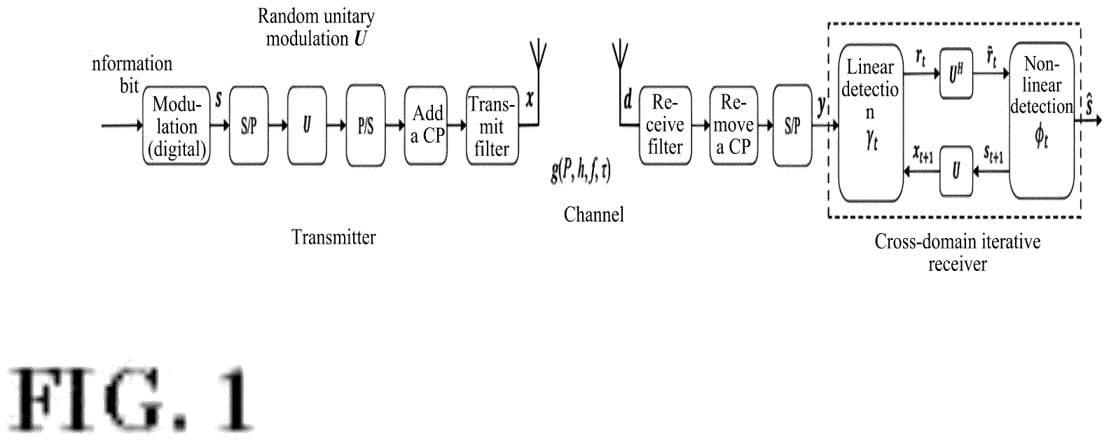

As shown in FIG. 1, the random unitary modulation specifically includes: performing digital modulation on an information bit sequence at a transmitter, performing S/P conversion on modulated information and performing random unitary modulation on the modulated information through a random unitary transformation matrix, adding a CP to a signal vector after the random unitary modulation, and transmitting the signal vector to a channel after passing through a transmit filter.

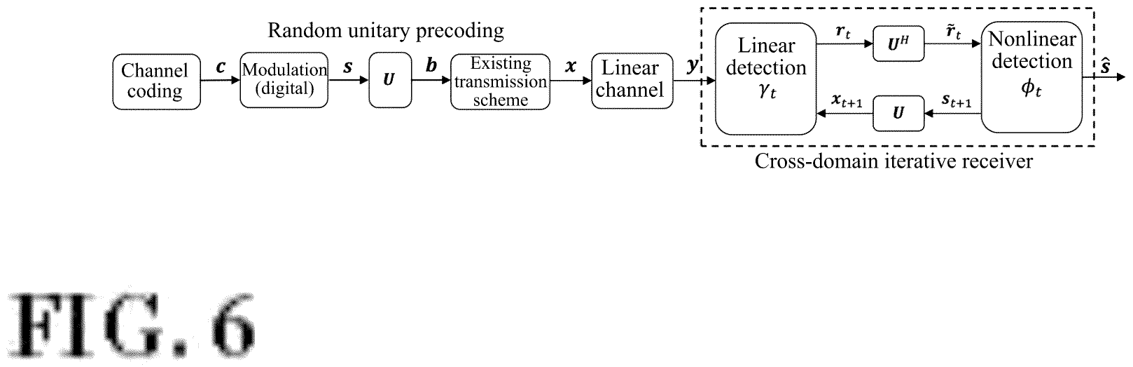

As shown in FIG. 6, the random unitary precoding specifically includes: performing channel coding and digital modulation on an information bit sequence at a transmitter, performing unitary precoding on modulated information through a random unitary transformation matrix to obtain a new symbol sequence, and combining the new symbol sequence with an existing transmission scheme to obtain a transmission signal for transmission. The cross-domain iterative detection includes using a cross-domain iterative receiver to receive the signal obtained after the random unitary coding modulation.

Embodiment 1: This embodiment provides implementation steps for the random unitary coding modulation using the random unitary modulation, and specifically includes:

### Transmitting End:

As shown in FIG. 1, on the transmitter, the information bit sequence is digitally modulated as s∈ [symbol] ^{N×1}, a power constraint is

$$\frac{1}{N} {‖ S ‖}^{2} = 1 ,$$

and element symbols are selected from a constellation S (for example, digital modulation such as quadrature phase shift keying (QPSK) and 16 quadrature amplitude modulation (16QAM)). After S/P conversion and random unitary modulation, an obtained signal vector x is:

x=Us.

U is a random unitary transformation matrix, UU^{H}=1, and I represents an identity matrix. In order to overcome the influences of inter-frame interference and multipath propagation, a CP is added to x, which is transmitted to the channel after passing through the transmit filter. A received signal d [n] in an n^{th} time slot is:

$$d [ n ] = {\sum }_{p = 0}^{P - 1} x [ n - p ] g [ n , p ] + w [ n ] .$$

w˜CN(0,σ²I) is an additive white Gaussian noise, and a time-varying channel response g[n,p] is:

$$g [ n , p ] = {\sum }_{i = 1}^{L} {h}_{i} {e}^{j 2 π {f}_{i} ( n {T}_{s} - p {T}_{s} )} {P}_{r c} ( p {T}_{s} - {τ}_{i} ) .$$

p=0, . . . , P−1 and P are channel segments, L is the number of multipaths, Tₛ is a system sampling interval, {hᵢ, fᵢ, τᵢ} respectively represent a complex gain, a Doppler shift, and a delay on an i^{th} path. τₘₐₓ≙max(τᵢ)<N, P is determined by Tₘₐₓ and response duration of a receive filter, and P_{rc}[⋅] is a sampled raised cosine roll-off filter.

### Receiving End:

After passing through the receive filter and removing the CP, a received signal y is denoted as:

$$y = Hx + w = HUs + w = {H}_{eff} s + w .$$

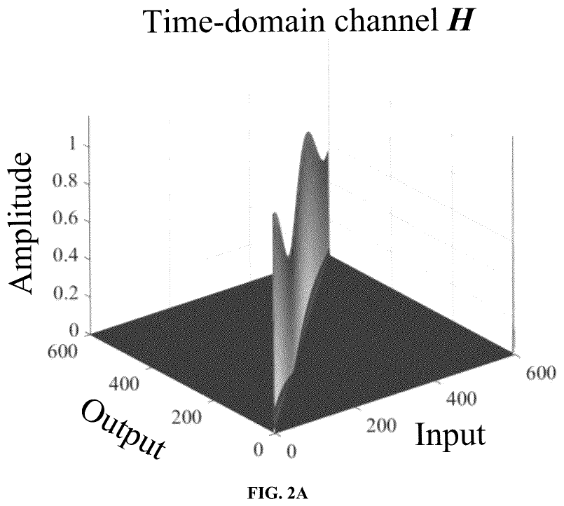

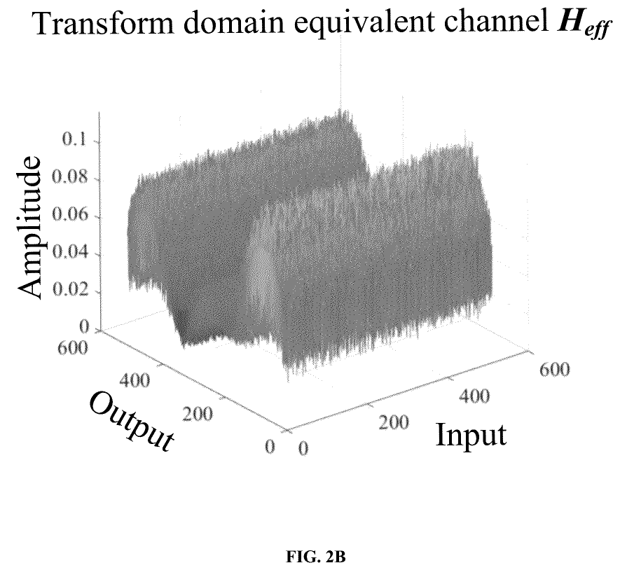

H∈ [symbol] ^{N×N} is a time-domain channel and H_{eff}≙HU is a transform domain equivalent channel. FIGS. 2A-2B show the comparison between the time-domain channel H and the transform domain equivalent channel H_{eff}, to verify the role of random unitary transformation. It is noted that H_{eff} ratio is more stable than H and is beneficial to signal recovery.

Aiming at the detection of random unitary modulation, the present disclosure provides a Bayesian optimal cross-domain iterative receiver. As shown in FIG. 1, the receiver consists of linear detection and inverse random unitary transformation in time domain, and nonlinear detection and random unitary transformation in transform domain, and the general form is as follows:
Linear detection: rₜ=γₜ(xₜ).
Inverse random unitary transformation: \tilde{r}ₜ=U^{H}rₜ.
Nonlinear detection: sₜ₊₁=ϕₜ(\tilde{r}ₜ).
Random unitary transformation: xₜ₊₁=Usₜ₊₁.
t denotes the number of iterations. Specifically, in a t^{th} iteration, based on a received signal y and priori estimation xₜ obtained through nonlinear detection, linear detection is performed to output an estimated signal rₜ, and inverse random unitary transformation is performed to obtain a signal t. Further, nonlinear detection is performed to obtain an output estimated signal sₜ₊₁, random unitary transformation is performed to generate xₜ₊₁, and xₜ₊₁ is input to linear detection. After a plurality of iterations, the whole detection process ends until the estimated signal sₜ₊₁ can be accurately recovered or a preset maximum iteration count is reached.

Considering that the time-domain LMMSE detection in the existing CD-OAMP receivers does not fully exploit the sparsity of the time-domain channel due to matrix inversion, high complexity is caused in CD-OAMP detection. Therefore, the present disclosure proposes a low-complexity CD-MAMP receiver based on the framework of the Bayesian optimal cross-domain iterative receiver shown in FIG. 1. In the linear detection, the time-domain memory MF is used to multiply a sparse time-domain channel matrix with an input signal, fully exploiting the sparsity of the time-domain channel to achieve Bayesian optimal performance with extremely low complexity. As shown in FIG. 8, the CD-MAMP receiver consists of orthogonal memory MF, inverse random unitary transformation, orthogonal MMSE demodulation, and random unitary transformation. Linear detection employs the orthogonal memory MF, and nonlinear detection employs orthogonal MMSE demodulation. Considering the t^{th} iteration process, details are as follows:
1) Orthogonal memory MF: based on a received signal y and an estimated value xₜ output from random unitary transformation, an estimated value output from the orthogonal memory MF is:

$${r}_{t} = {γ}_{t} ( {X}_{t} ) = \frac{1}{{ε}_{t}^{γ}} ( {\hat{γ}}_{t} ( {X}_{t} ) - {X}_{t} {p}_{t} ) .$$

$${X}_{t} = [ {x}_{1} , … , {x}_{t} ] , {\hat{γ}}_{t} ( {X}_{t} ) = {H}^{H} {\tilde{γ}}_{t} ( {X}_{t} ) , and$$

$${\tilde{γ}}_{t} ( {X}_{t} ) = {B}_{t} {\tilde{γ}}_{t - 1} ( {X}_{t - 1} ) + {ξ}_{t} ( y - H {x}_{t} ) .$$

\tilde{γ}₀(X₀)=0, Bₜ=θₜ(λ^{†}I−HH^{H}), {pₜ,εₜ^{γ},ξₜ, λ^{†},θₜ} is used to ensure the convergence and orthogonality of MAMP, and the specific expression is as follows:

$${p}_{t} = [ {p}_{t , 1} , {p}_{t , 2} , … , {p}_{t , t} ]$$

$${p}_{t , i} = - {ϑ}_{t - i} , {w}_{t - 1}$$

$${ε}_{t}^{γ} = - {\sum }_{i = 1}^{t} {p}_{t , i}$$

$${ξ}_{t} = \{ \begin{matrix}\frac{{c}_{t , 2} {c}_{t , 0} + {c}_{t , 3}}{{c}_{t , 1} {c}_{t , 0} + {c}_{t , 2}} & if {c}_{t , 1} {c}_{t , 0} + {c}_{t , 2} \neq 0 \\ + ∞ , & otherwise\end{matrix}$$

$${λ}^{†} = ( λ {max}_{min}$$

$${θ}_{t} = {( {λ}^{†} + {ρ}_{t} )}^{- 1}$$

$${ρ}_{t} = {σ}^{2} / {v}_{t + 1 , t + 1}^{ϕ} , {ϑ}_{t , i} ≡ \{ \begin{matrix}{ξ}_{t} , & i = t \\ {ξ}_{i} {\prod }_{τ = i + 1}^{t} {θ}_{τ} , & i < t\end{matrix} , {W}_{t} ≡ {A}^{H} {B}^{t} A , {b}_{t} ≡ \frac{1}{N} t r \{ {B}^{t} \} = {\sum }_{i = 0}^{t} ( \begin{matrix}t \\ i\end{matrix} ) {( - 1 )}^{i} {( {λ}^{†} )}^{t - i} {λ}_{i} , {w}_{t} ≡ \frac{1}{N} t r \{ {W}_{t} \} = {λ}^{†} {b}_{t} - {b}_{t + 1} ,$$

and λₘᵢₙ and λₘₐₓ are a minimum eigenvalue and a maximum eigenvalue of AA^{H} respectively: An output estimated variance of γₜ(⋅) is:

$${v}_{t , t}^{γ} ≡ \frac{1}{N} E \{ {‖ {γ}_{t} ( {X}_{t} ) - x ‖}^{2} \} .$$

Due to the orthogonality between the current output estimated error and the estimated errors of all previous inputs, the estimated error exhibits asymptotic independent and identically distributed (ID) Gaussianity, that is, rₜ=x+zₜ^{γ}. zₜ^{γ}˜CN(0,v_{t,t}^{γ}I) is a Gaussian noise independent of x.
2) Inverse random unitary transformation: Through inverse random unitary transformation U^{H}, the estimated value \tilde{r}ₜ and variance \tilde{v}_{t,t}^{γ} in time domain can be obtained:

\tilde{r}ₜ=U^{H}rₜ, and

\tilde{v}_{t,t}^{γ}=v_{t,t}^{γ}.

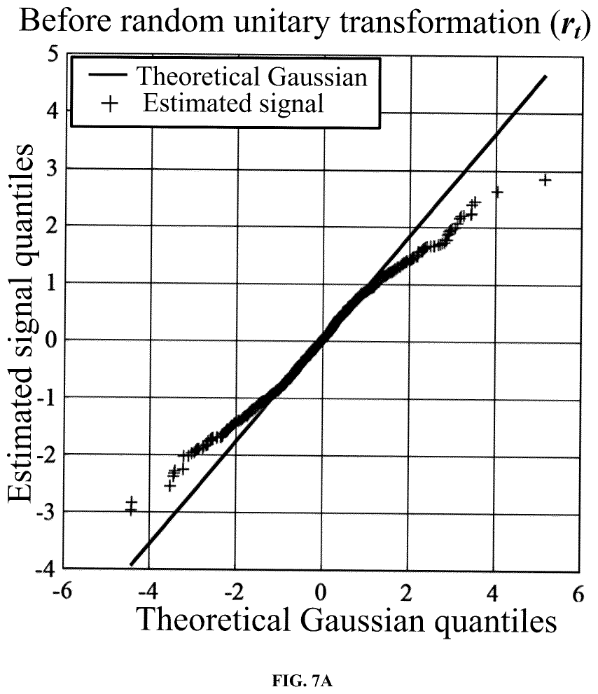

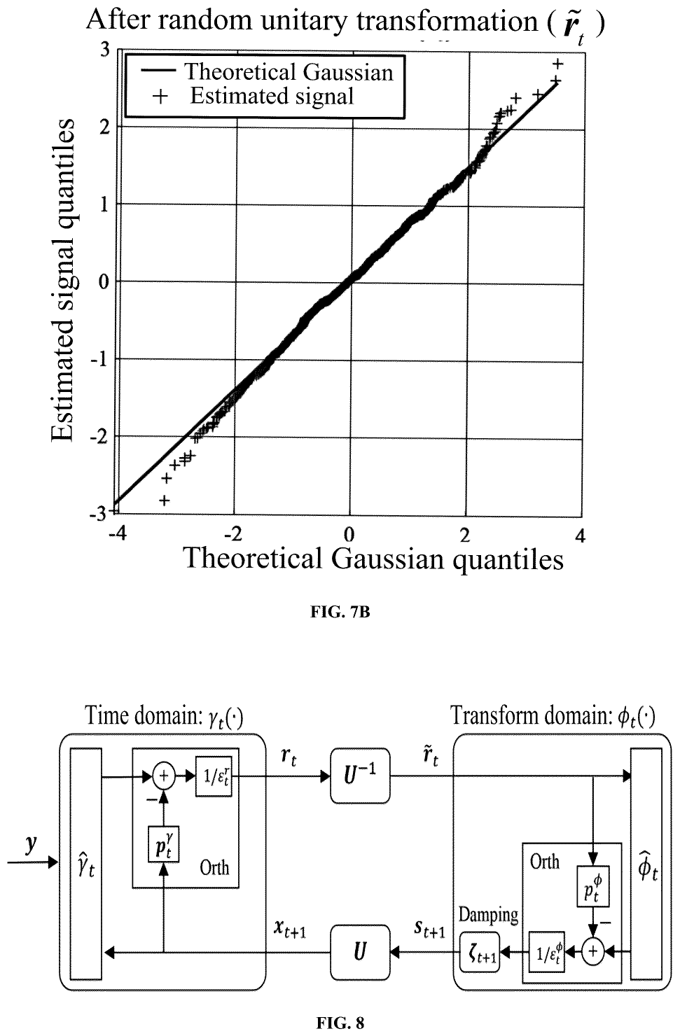

Through the properties of the random unitary transformation, the IID Gaussianity of the error in \tilde{r}ₜ can be enhanced, that is, \tilde{r}ₜ=s+\tilde{z}ₜ^{γ}, where \tilde{z}ₜ^{γ}=U⁻¹zₜ^{γ}˜CN(0,v_{t,t}^{γ},I). As shown in FIGS. 7A-7B, \tilde{r}ₜ is closer to a Gaussian signal with a mean of s and a variance of zₜ^{γ}.
3) Orthogonal MMSE demodulation: ϕₜ(⋅) consists of symbol-by-symbol MMSE demodulation \hat{ϕ}ₜ(⋅), orthogonalization and damping, and the output estimated value sₜ₊₁ is:

$${s}_{t + 1} = {ϕ}_{t} ( {\tilde{r}}_{t} ) = [ {s}_{1} , … , {s}_{t} , {\hat{s}}_{t + 1} ] \cdot {ζ}_{t + 1} .$$

$${\hat{s}}_{t + 1} = \frac{1}{{ε}_{t}^{ϕ}} ( {\hat{ϕ}}_{t} ( {\tilde{r}}_{t} ) - {p}_{t}^{ϕ} {\tilde{r}}_{t} ) ,$$

\hat{ϕ}ₜ(\tilde{r}ₜ)=E{s|\tilde{r}ₜ}, {εₜ^{ϕ},pₜ^{ϕ}} are normalization and orthogonal coefficients, ζₜ₊₁ is a damping vector, and the output variance \tilde{v}^{ϕ}_{t+1,t+1} of ϕₜ(⋅) is:

$${\tilde{v}}_{t + 1 , t + 1}^{ϕ} ≡ \frac{1}{N} E \{ {‖ {ϕ}_{t} ( {\tilde{r}}_{t} ) - s ‖}^{2} \} .$$

4) Random unitary transformation: Through random unitary transformation U, the estimated value xₜ₊₁ and variance v^{ϕ}_{t+1,t+1} in transform domain can be obtained:

$${x}_{t + 1} = U {s}_{t + 1} , and$$

$${v}_{t + 1 , t + 1}^{ϕ} = {\tilde{v}}_{t + 1 , t + 1}^{ϕ} .$$

Then the estimated value xₜ₊₁ and variance v^{ϕ}_{t+1,t+1} are fed back to the orthogonal memory MF.

The whole CD-MAMP receiver goes through a plurality of iterations, and the whole detection process ends until the estimated signal sₜ₊₁ can be accurately recovered or the preset maximum iteration count is reached.

Embodiment 2: This embodiment provides implementation steps for the random unitary coding modulation using the random unitary modulation in a MIMO scenario.

### Scheme 1:

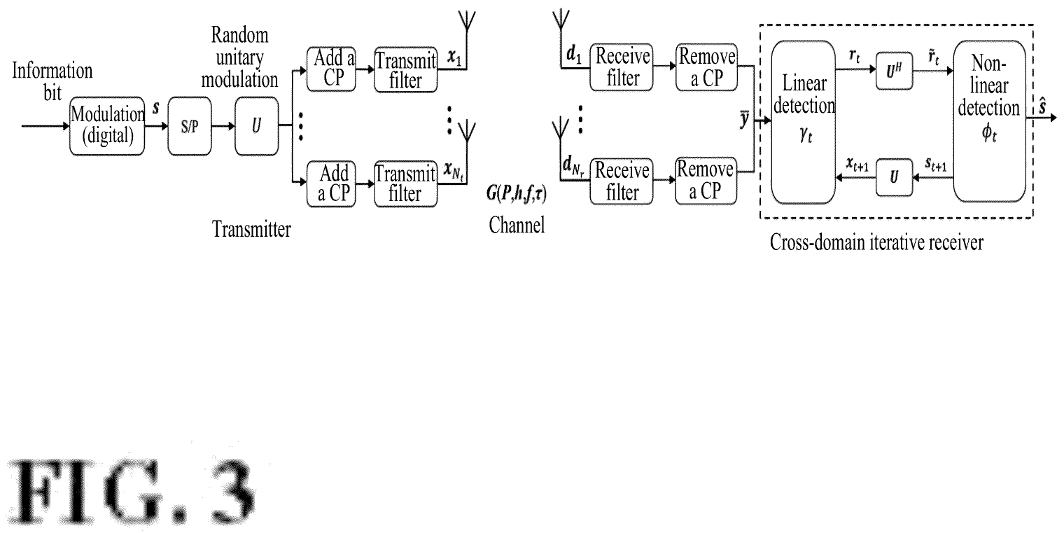

Transmitting end: As shown in FIG. 3, a digital modulation signal s is segmented into Nₜ segments after S/P conversion and random unitary modulation, a CP is added to each segment, a time-domain signal x; is obtained through a transmit filter and sent to a channel on a j^{th} antenna (j=1, . . . , Nᵣ). A channel impulse response from the j^{th} transmitting antenna to an m^{th} receiving antenna is:

$${g}_{m , j} [ n , p ] = {\sum }_{i = 1}^{{L}_{m , j}} {h}_{m , j , i} {e}^{j 2 π {f}_{m , j , i} ( {nT}_{s} - {pT}_{s} )} {P}_{rc} ( {pT}_{s} - {τ}_{m , j , i} ) .$$

n=0, . . . , N−1, m=1, . . . , Nᵣ, p=0, . . . , P_{m,j}−1, and L_{m,j} is the number of multipaths between the j^{th} transmitting antenna and the m^{th} receiving antenna. h_{m,j,i}, f_{m,j,i}, τ_{m,j,i} respectively represent a channel gain, a Doppler shift, and a delay related to the i^{th} path.

Receiving end: The received signal on the m^{th} antenna of the receiving end passes through the receive filter and CP is removed to obtain the received signal in time domain:

$${\overline{y}}_{m} [ n ] = {\sum }_{j = 1}^{{N}_{l}} {\sum }_{p = 0}^{{P}_{m , j} - 1} {g}_{m , j} [ n , p ] {x}_{j} [ {[ c - p ]}_{N} ] + {\overline{w}}_{m} [ n ] .$$

Then the received signal of random unitary modulation in a MIMO system can be expressed as a matrix, that is:

y̅=H̅x̅+w̅.

x̅=[x₁^{T}, . . . ,x_{N}_{ₜ}^{T}]^{T},\tilde{H}=[H₁^{T}, . . . ,H_{N}_{ₜ}^{T}]^{T},w̅=[w̅₁^{T}, . . . ,w̅_{N}_{ₜ}^{T}]^{T}.

Based on the received signal y̅, the cross-domain iterative receiver recovers the estimated signal ŝ. The process of the cross-domain iterative receiver is as follows: Linear detection: rₜ=γₜ(xₜ).

Inverse random unitary transformation: \tilde{r}t=U^{H}rₜ.

Nonlinear detection: sₜ₊₁=ϕₜ(\tilde{r}ₜ).

Random unitary transformation: xₜ₊₁=Usₜ₊₁. t denotes the number of iterations. Specifically, in a t^{th} iteration, based on a received signal y̅ and priori estimation xₜ obtained through nonlinear detection, linear detection is performed to output an estimated signal rₜ, and inverse random unitary transformation is performed to obtain a signal \tilde{r}ₜ. Further, nonlinear detection is performed to obtain an output estimated signal ŝ=sₜ₊₁, random unitary transformation is performed to generate xₜ₊₁, and xₜ₊₁ is input to linear detection. After a plurality of iterations, the whole detection process ends until the estimated signal sₜ₊₁ can be accurately recovered or a preset maximum iteration count is reached.

The CD-MAMP receiver proposed in the present disclosure can be used for detection. Specifically,

1) Orthogonal memory MF: based on a received signal y̅ and an estimated value xₜ output from random unitary transformation, an estimated value output from the orthogonal memory MF is:

$${r}_{t} = {γ}_{t} ( {X}_{t} ) = \frac{1}{{ε}_{t}^{γ}} ( {\hat{γ}}_{t} ( {X}_{t} ) - {X}_{t} {p}_{t} ) . \\ {X}_{t} = [ {x}_{1} , … , {x}_{t} ] , {\hat{γ}}_{t} ( {X}_{t} ) = {\overline{H}}^{H} {\tilde{γ}}_{t} ( {X}_{t} ) , and \\ {\tilde{γ}}_{t} ( {X}_{t} ) = {B}_{t} {\tilde{γ}}_{t - 1} ( {X}_{t - 1} ) + {ξ}_{t} ( \overline{y} - \overline{H} {x}_{t} ) .$$

\tilde{γ}₀(X₀)=0, Bₜ=θₜ(λ^{†}I−H̅H̅^{H}), and {εₜ^{γ}, pₜ, ξₜ, θₜ, λ^{†}} is used to ensure the convergence and orthogonality of MAMP. {εₜ^{γ}, pₜ, ξₜ, θₜ, λ^{†}} is used to ensure the convergence and orthogonality of MAMP, and the specific expression is as follows:

$${p}_{t} = [ {p}_{t , 1} , {p}_{t , 2} , … , {p}_{t , t} ] \\ {p}_{t , i} = - {ϑ}_{t , i} {w}_{t - i} \\ {ε}_{t}^{γ} = - {\sum }_{i = 1}^{t} {p}_{t , i} \\ {ξ}_{t} = \{ \begin{matrix}\frac{{c}_{t , 2} {c}_{t , 0} + {c}_{t , 3}}{{c}_{t , 1} {c}_{t , 0} + {c}_{t , 2}} , & if {c}_{t , 1} {c}_{t , 0} + {c}_{t , 2} \neq 0 \\ + ∞ , & otherwise\end{matrix} \\ {λ}^{†} = ( λ {max}_{m i n} \\ {θ}_{t} = {( {λ}^{†} + {ρ}_{t} )}^{- 1} \\ {ρ}_{t} = {σ}^{2} / {v}_{t + 1 , t + 1}^{ϕ} , \\ {ϑ}_{t , i} ≡ \{ \begin{matrix}{ξ}_{t} , & i = t \\ {ξ}_{i} {\prod }_{τ = i + 1}^{t} {θ}_{τ} , & i < t\end{matrix} , \\ {W}_{t} ≡ {A}^{H} {B}^{t} A , \\ {b}_{t} ≡ \frac{1}{N} tr \{ {B}^{t} \} = {\sum }_{i = 0}^{t} ( \begin{matrix}t \\ i\end{matrix} ) {( - 1 )}^{i} {( {λ}^{†} )}^{t - i} {λ}_{i} , \\ {w}_{t} ≡ \frac{1}{N} tr \{ {W}_{t} \} = {λ}^{†} {b}_{t} - {b}_{t + 1} ,$$

and λₘᵢₙ and λₘₐₓ are a minimum eigenvalue and a maximum eigenvalue of AA^{H} respectively. An output estimated variance of γₜ(⋅) is:

$${v}_{t , t}^{γ} ≡ \frac{1}{N} E \{ {‖ {γ}_{t} ( {X}_{t} ) - x ‖}^{2} \} .$$

Due to the orthogonality between the current output estimated error and the estimated errors of all previous inputs, the estimated error exhibits asymptotic IID Gaussianity, that is, rₜ=x+zₜ^{γ}. zₜ^{γ}˜CN(0, v_{t,t}^{γ},I) is a Gaussian noise independent of x.

2) Inverse random unitary transformation: Through inverse random unitary transformation U^{H}, the estimated value \tilde{r}^{t} and variance \tilde{v}_{t,t}^{γ} in time domain can be obtained:

\tilde{r}ₜ=U^{H}rₜ, and

\tilde{v}_{t,t}^{γ}=v_{t,t}^{γ}.

Through the properties of the random unitary transformation, the IID Gaussianity of the error in \tilde{r}ₜ can be enhanced, that is, \tilde{r}ₜ=s+\tilde{z}ₜ^{γ}, where \tilde{z}ₜ^{γ}=U⁻¹zₜ^{γ}˜CN(0,v_{t,t}^{γ}I). As shown in FIGS. 7A-7B, \tilde{r}ₜ is closer to a Gaussian signal with a mean of s and a variance of zₜ^{γ}.

3) Orthogonal MMSE demodulation: ϕₜ(⋅) consists of symbol-by-symbol MMSE demodulation \hat{ϕ}ₜ(⋅), orthogonalization and damping, and the output estimated value sₜ₊₁ is:

$${s}_{t + 1} = {ϕ}_{t} ( {\tilde{r}}_{t} ) = [ {s}_{1} , … , {s}_{t} , {\hat{s}}_{t + 1} ] \cdot {ζ}_{t + 1} , and \\ {\hat{s}}_{t + 1} = \frac{1}{{ε}_{t}^{ϕ}} ( {\hat{ϕ}}_{t} ( {\tilde{r}}_{t} ) - {p}_{t}^{ϕ} {\tilde{r}}_{t} ) ,$$

\hat{ϕ}ₜ(\tilde{r}ₜ)=E{s|\tilde{r}ₜ}, {εₜ^{ϕ},pₜ^{ϕ}} are normalization and orthogonal coefficients, ζₜ₊₁ is a damping vector, and the output variance \tilde{v}^{ϕ}_{t+1,t+1} of ϕₜ(⋅) is:

$${\tilde{v}}_{t + 1 , t + 1}^{ϕ} ≡ \frac{1}{N} E \{ {‖ {ϕ}_{t} ( {\tilde{r}}_{t} ) - s ‖}^{2} \} .$$

4) Random unitary transformation: Through random unitary transformation U, the estimated value xₜ₊₁ and variance v^{ϕ}_{t+1,t+1} in transform domain can be obtained:

$${x}_{t + 1} = {Us}_{t + 1} , and \\ {v}_{t + 1 , t + 1}^{ϕ} = {\tilde{v}}_{t + 1 , t + 1}^{ϕ} .$$

Then the estimated value xₜ₊₁ and variance v^{ϕ}_{t+1,t+1} are fed back to the orthogonal memory MF.

The whole CD-MAMP receiver goes through a plurality of iterations, and the whole detection process ends until the estimated signal ŝ=sₜ₊₁ can be accurately recovered or the preset maximum iteration count is reached.

### Scheme 2:

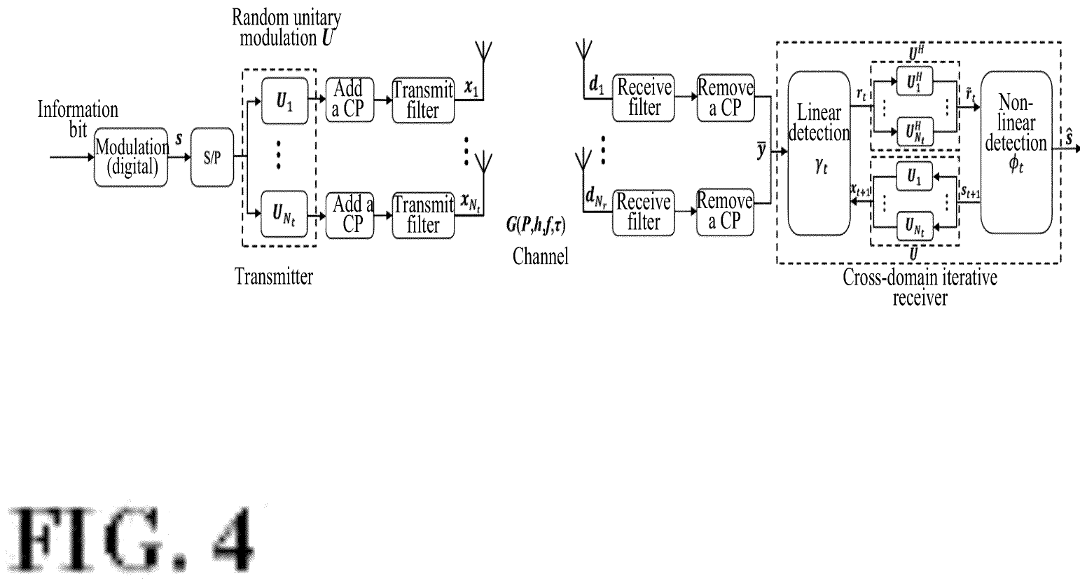

Transmitting end: As shown in FIG. 4, the digital modulation signal s is segmented into S segments after S/P conversion, random unitary modulation (that is, through a random unitary matrix U₁, . . . , U_{N}_{ₜ}) is performed on each segment, a CP is added to each segment, and a signal X₁, . . . , X_{N}_{ₜ} is generated through the transmit filter.

Receiving end: The difference from the receiving end in Scheme 1 lies in the inverse random unitary transformation and random unitary transformation in the cross-domain iterative receiver. Specifically, the estimated signal rₜ output from linear detection is segmented into Nₜ segments, inverse random unitary modulation (that is, through an inverse random unitary matrix U₁^{H}, . . . , U_{N}_{ₜ}^{H}) is performed on each segment, then the segments are combined to obtain an estimated signal \tilde{r}ₜ, which is input into nonlinear detection. An estimated signal sₜ₊₁ output from nonlinear detection is segmented into Nₜ segments, and random unitary modulation (that is, through an inverse random unitary matrix U₁, . . . , U_{N}_{ₜ}) is performed on each segment, then the segments are combined to obtain an estimated signal xₜ₊₁, which is input into linear detection.

### Scheme 3:

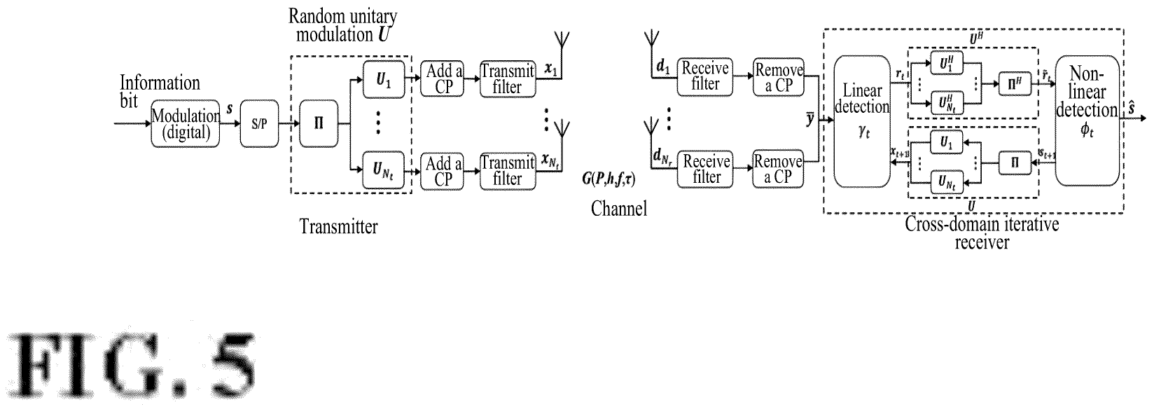

Transmitting end: As shown in FIG. 5, the digital modulation signal s is segmented into Nₜ segments after S/P conversion and a random permutation matrix Π, and random unitary modulation (that is, through a random unitary matrix U₁, . . . , U_{N}_{ₜ}) is performed on each segment, a CP is added to each segment, and a signal x₁, . . . , X_{N}_{ₜ} is generated through the transmit filter.

Receiving end: The difference from the receiving end in Scheme 1 lies in the inverse random unitary transformation and random unitary transformation in the cross-domain iterative receiver. Specifically, the estimated signal rₜ output from linear detection is segmented into Nₜ segments, inverse random unitary modulation (that is, through an inverse random unitary matrix U₁^{H}, . . . , U_{N}_{ₜ}^{H}) is performed on each segment, then the segments are combined and input into the random permutation inverse matrix Π^{H} to obtain an estimated signal \tilde{r}ₜ, which is input into nonlinear detection. An estimated signal sₜ₊₁ output from nonlinear detection is segmented into Nₜ segments, input into the random permutation matrix Π and then segmented into Nₜ segments, and random unitary modulation (that is, through an inverse random unitary matrix U₁, . . . , U_{N}_{ₜ}) is performed on each segment, then the segments are combined to obtain an estimated signal xₜ₊₁, which is input into linear detection.

Embodiment 3: This embodiment provides implementation steps for the random unitary coding modulation using the random unitary precoding, and specifically includes:
Transmitting end: FIG. 6 shows a communication system that uses a random unitary matrix as the precoding scheme. First, channel coding is performed on an information bit sequence to generate a sequence c. Then, through digital modulation, the sequence is mapped into a symbol sequence s. s is precoded using the random unitary matrix U to obtain a new symbol sequence b, that is, b=Us, and a transmission coincidence sequence x is generated through the existing transmission scheme, which is expressed as x=Pb=PUs. Finally, the sequence x is transmitted to the channel.

Receiving end: A signal received by the receiving end is expressed as:

$$y = Hx + w = HPUs + w = {H}_{eff} s + w .$$

H_{eff}=HPU. Based on y, the channel matrix H, the transmission scheme P, the random unitary precoding matrix U, and priori information of s, ŝ can be recovered using a cross-domain iterative receiver.

Based on the received signal y, the cross-domain iterative receiver recovers the estimated signal ŝ. The process of the cross-domain iterative receiver is as follows: Linear detection: rₜ=γₜ(xₜ).

Inverse random unitary transformation: \tilde{r}ₜ=U^{H}rₜ.

Nonlinear detection: sₜ₊₁=ϕₜ(\tilde{r}ₜ).

Random unitary transformation: xₜ₊₁=Usₜ₊₁. t denotes the number of iterations. Specifically, in a t^{th} iteration, based on a received signal y̅ and priori estimation xₜ obtained through nonlinear detection, linear detection is performed to output an estimated signal rₜ, and inverse random unitary transformation is performed to obtain a signal \tilde{r}ₜ. Further, nonlinear detection is performed to obtain an output estimated signal ŝ=sₜ₊₁, random unitary transformation is performed to generate xₜ₊₁, and xₜ₊₁ is input to linear detection. After a plurality of iterations, the whole detection process ends until the estimated signal sₜ₊₁ can be accurately recovered or a preset maximum iteration count is reached.

The CD-MAMP receiver proposed in the present disclosure can be used for detection. Specifically,

1) Orthogonal memory MF: based on a received signal y and an estimated value xₜ output from random unitary transformation, an estimated value output from the orthogonal memory MF is:

$${r}_{t} = {γ}_{t} ( {X}_{t} ) = \frac{1}{{ε}_{t}^{γ}} ( {\hat{γ}}_{t} ( {X}_{t} ) - {X}_{t} {p}_{t} ) . \\ {X}_{t} = [ {x}_{1} , … , {x}_{t} ] , {\hat{γ}}_{t} ( {X}_{t} ) = {H}^{H} {\tilde{γ}}_{t} ( {X}_{t} ) , and \\ {\tilde{γ}}_{t} ( {X}_{t} ) = {B}_{t} {\tilde{γ}}_{t - 1} ( {X}_{t - 1} ) + {ξ}_{t} ( y - {Hx}_{t} ) .$$

\tilde{γ}₀(X₀)=0, Bₜ=θₜ(λ^{†}I−HH^{H}), {pₜ,εₜ^{γ},ξₜ, λ^{†},θₜ} is used to ensure the convergence and orthogonality of MAMP, and the specific expression is as follows:

$${p}_{t} = [ {p}_{t , 1} , {p}_{t , 2} , … , {p}_{t , t} ] \\ {p}_{t , i} = - {ϑ}_{t , i} {w}_{t - i} \\ {ε}_{t}^{γ} = - {\sum }_{i = 1}^{t} {p}_{t , i} \\ {ξ}_{t} = \{ \begin{matrix}\frac{{c}_{t , 2} {c}_{t , 0} + {c}_{t , 3}}{{c}_{t , 1} {c}_{t , 0} + {c}_{t , 2}} , & if {c}_{t , 1} {c}_{t , 0} + {c}_{t , 2} \neq 0 \\ + ∞ , & otherwise\end{matrix} \\ {λ}^{†} = ( λ {max}_{m i n} \\ {θ}_{t} = {( {λ}^{†} + {ρ}_{t} )}^{- 1} \\ {ρ}_{t} = {σ}^{2} / {v}_{t + 1 , t + 1}^{ϕ} , \\ {ϑ}_{t , i} ≡ \{ \begin{matrix}{ξ}_{t} , & i = t \\ {ξ}_{i} {\prod }_{τ = i + 1}^{t} {θ}_{τ} , & i < t\end{matrix} , \\ {W}_{t} ≡ {A}^{H} {B}^{t} A , \\ {b}_{t} ≡ \frac{1}{N} tr \{ {B}^{t} \} = {\sum }_{i = 0}^{t} ( \begin{matrix}t \\ i\end{matrix} ) {( - 1 )}^{i} {( {λ}^{†} )}^{t - i} {λ}_{i} , \\ {w}_{t} ≡ \frac{1}{N} tr \{ {W}_{t} \} = {λ}^{†} {b}_{t} - {b}_{t + 1} ,$$

and λₘᵢₙ and λₘₐₓ are a minimum eigenvalue and a maximum eigenvalue of AA^{H} respectively. According to (17), an output estimated variance of γₜ(⋅) is:

$${v}_{t , t}^{γ} ≡ \frac{1}{N} E \{ {‖ {γ}_{t} ( {X}_{t} ) - x ‖}^{2} \} .$$

Due to the orthogonality between the current output estimated error and the estimated errors of all previous inputs, the estimated error exhibits asymptotic IID Gaussianity, that is, rₜ=x+zₜ^{γ}. zₜ^{γ}˜CN(0,v_{t,t}^{γ}I) is a Gaussian noise independent of x.

2) Inverse random unitary transformation: Through inverse random unitary transformation U^{H}, the estimated value \tilde{r}ₜ and variance \tilde{v}_{t,t}^{γ} in time domain can be obtained:

\tilde{r}ₜ=U^{H}rₜ.

\tilde{v}_{t,t}^{γ}=v_{t,t}^{γ}.

Through the properties of the random unitary transformation, the IID Gaussianity of the error in \tilde{r}ₜ can be enhanced, that is, \tilde{r}ₜ=s+\tilde{z}ₜ^{γ}, where \tilde{z}ₜ^{γ}=U⁻¹zₜ^{γ}˜CN(0,v_{t,t}^{I}). As shown in FIGS. 7A-7B, \tilde{r}ₜ is closer to a Gaussian signal with a mean of s and a variance of zₜ^{γ}.

3) Orthogonal MMSE demodulation: ϕₜ(⋅) consists of symbol-by-symbol MMSE demodulation \hat{Φ}ₜ(⋅), orthogonalization and damping, and the output estimated value sₜ₊₁ is:

$${s}_{t + 1} = {ϕ}_{t} ( {\tilde{r}}_{t} ) = [ {s}_{1} , … , {s}_{t} , {\hat{s}}_{t + 1} ] \cdot {ζ}_{t + 1} . \\ {\hat{s}}_{t + 1} = \frac{1}{{ε}_{t}^{ϕ}} ( {\hat{ϕ}}_{t} ( {\tilde{r}}_{t} ) - {p}_{t}^{ϕ} {\tilde{r}}_{t} ) ,$$

\hat{ϕ}(\tilde{r}ₜ)=E{s|\tilde{r}ₜ}, {εₜ^{ϕ}, pₜ^{ϕ}} are normalization and orthogonal coefficients, ζₜ₊₁ is a damping vector, and the output variance, v^{ϕ}_{t+1,t+1} of ϕₜ(⋅) is:

$${\tilde{v}}_{t + 1 , t + 1}^{ϕ} ≡ \frac{1}{N} E \{ {‖ {ϕ}_{t} ( {\tilde{r}}_{t} ) - s ‖}^{2} \} .$$

4) Random unitary transformation: Through random unitary transformation U, the estimated value xₜ₊₁ and variance v^{ϕ}_{t+1,t+1} in transform domain can be obtained:

$${x}_{t + 1} = {Us}_{t + 1} . \\ {v}_{t + 1 , t + 1}^{ϕ} = {\tilde{v}}_{t + 1 , t + 1}^{ϕ} .$$

Then the estimated value xₜ₊₁ and variance v^{ϕ}_{t+1,t+1} are fed back to the orthogonal memory MF.

The whole CD-MAMP receiver goes through a plurality of iterations, and the whole detection process ends until the estimated signal ŝ=sₜ₊₁ can be accurately recovered or the preset maximum iteration count is reached.

The existing multicarrier modulation techniques (such as OFDM, OTFS, and AFDM) are primarily focused on minimizing inter-symbol interference and obtaining an equivalent sparse channel matrix, allowing for the use of simplified, low-complexity receivers to recover the signal. However, each signal only experiences limited channel fading, leading to degradation in detection performance.

In contrast, the random unitary modulation proposed in the present disclosure is a non-orthogonal transmission method that randomly superimposes all signals together, allowing each signal to experience statistically stationary channel fading, thereby ensuring the achievement of maximum diversity gain.

In addition, the random unitary modulation proposed in the present disclosure can also be used as a precoding method, applicable to communication systems characterized by standard linear models.

In terms of the receiver, the random unitary modulation with CD-MAMP in the present disclosure achieves performance far superior to OFDM, OTFS, and AFDM with extremely low complexity.

Next, numerical simulation results are presented using IFDM in random unitary modulation as an example.

For simplicity, the simulation parameters are set as follows: the carrier frequency is 4 GHz, the subcarrier spacing is Δf=15 kHz, the speed of the mobile station is {300 km/h, 500 km/h}, the maximum Doppler shift is vₘₐₓ={1111,1852} Hz, the channel Doppler shift is generated by Jakes information, and the roll-off factor of the root raised cosine (RRC) filter in the transceiver is set to 0.4, N=M=512 (in OTFS, the number of subcarriers is 32 and the number of time slots is 16), and the signal-to-noise ratio is defined as E{∥Hₓ∥²}/σ².

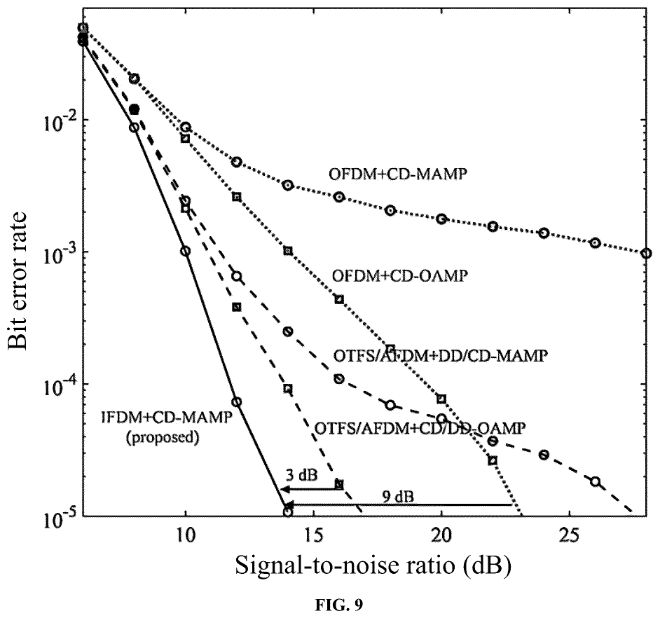

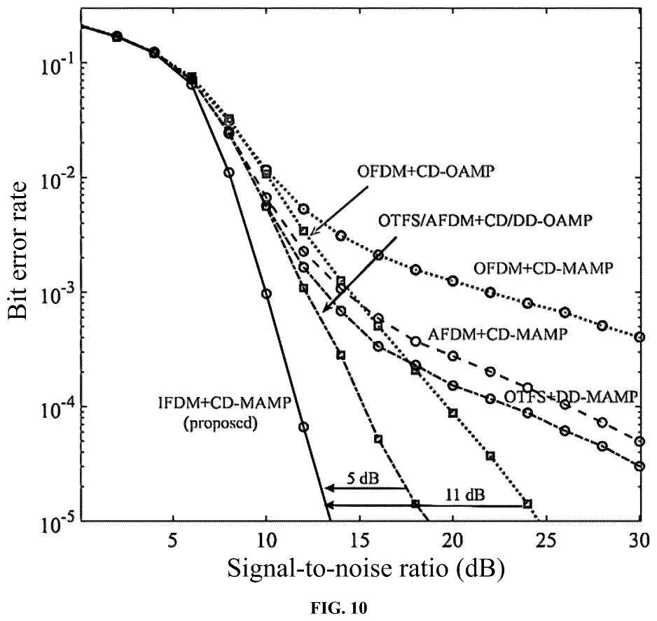

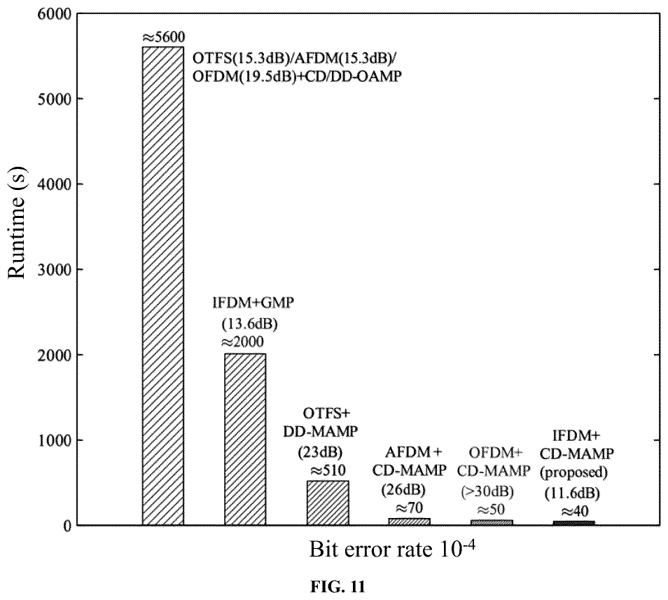

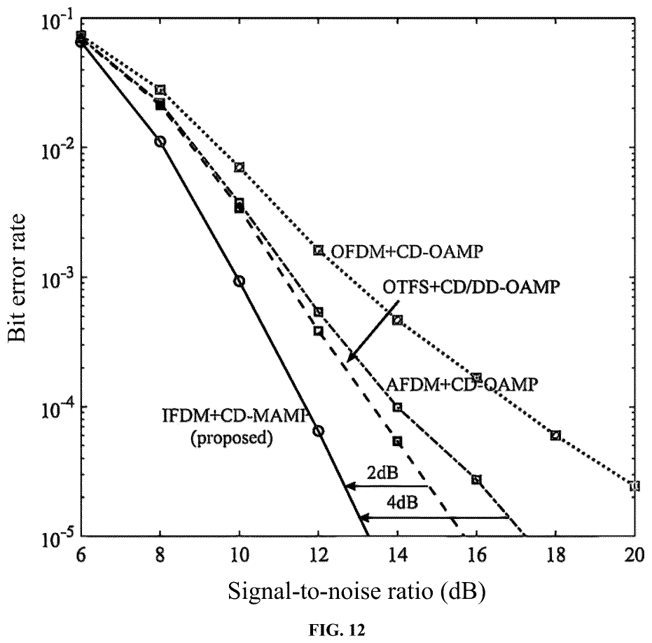

FIG. 9 and FIG. 10 show the BER performance comparisons of IFDM, OFDM, OTFS, and AFDM using CD/DD-OAMP and CD/DD-MAMP receivers in SISO and 4*4 MIMO scenarios to validate the performance advantage of IFDM. In FIG. 10, Nᵣ=Nₛ=4. When the BER is 10⁻⁵ and the speed is 300 km/h, in the SISO scenario, IFDM using the CD-MAMP receiver achieves 3 dB and 9 dB gains compared to OTFS/AFDM using the OAMP receiver and OTFS/AFDM using MAMP the receiver, respectively. In the MIMO scenario, IFDM using the CD-MAMP receiver achieves over 5 dB gain compared to OTFS, AFDM, and OFDM using the OAMP receiver. FIG. 11 shows that when the BER is 10⁻⁵ and the speed is 500 km/h, in the SISO scenario, IFDM using the CD-MAMP receiver achieves 2 dB and 4 dB gains compared to OTFS/AFDM using the OAMP receiver.

FIG. 12 further compares the runtime in the 4*4 MIMO scenario when the BER is 10⁻⁴, and Nᵣ=Nₛ=4. It is noted that the runtime of MIMO-IFDM using the CD-MAMP receiver is only 0.7% of that for OTFS/AFDM using the CD/DD-OAMP receiver, 8% of MIMO-OTFS using the DD-MAMP receiver, and slightly lower than MIMO-OTFS/OFDM using the CD-MAMP receiver.

To further validate the advantages of IFDM and CD-MAMP, Table 1 summarizes the comparison of different modulation schemes. Table 2 compares different receivers, where T is the maximum iteration count for the receiver.

TABLE 1
Comparison of OFDM, OTFS, AFDM, and IFDM

| | | | Equivalent | BER |
|---|---|---|---|---|
| Modulation | Transform | Modulation | channel matrix | performance |
| scheme | domain | complexity | type | ranking |
| OFDM | Frequency | O(N log N) | $\frac{Diagonal ( static )}{Dense ( dynamic )}$ | 3 (worst) |
| OTFS | DD | $O ( \frac{3}{2} N log N )$ | Sparse | 2 |
| AFDM | DAFT | O(N log N) | Sparse | |
| IFDM | IF | O(N log N) | Random dense | 1 (best) |

TABLE 2
Comparison of Different Receivers

| Receiver | | Performance ranking | |
|---|---|---|---|
| Algorithm | Complexity | Complexity | BER |
| LMMSE | O(N³) | 4 | 3 |
| | | | (worst) |
| GMP (instable, affected | O(N²T) | 3 | 2 |
| by the damping coefficient) | | | |
| CD-OAMP | O(N³T + | 6 | 1 |
| | 2NT log N) | (worst) | (best) |
| DD-OAMP | O(N³T) | 5 | |
| DD-MAMP | O(N²T) | 2 | |

The above embodiments are intended to explain the present disclosure, rather than to limit the present disclosure. Any modifications and changes made to the present disclosure within the spirit and the protection scope defined by the claims should all fall within the protection scope of the present disclosure.

What is claimed is:

1. A signal transmission method based on random unitary coding modulation and cross-domain iterative detection, wherein the method comprises random unitary coding modulation at a signal transmitting end and cross-domain iterative detection at a receiving end;
the random unitary coding modulation is achieved through random unitary modulation or random unitary precoding;
the random unitary modulation comprises: performing digital modulation on an information bit sequence at a transmitter, performing serial-to-parallel (S/P) conversion on modulated information and performing the random unitary modulation on the modulated information through a random unitary transformation matrix, adding a cyclic prefix (CP) to a signal vector after the random unitary modulation, and transmitting the signal vector to a channel after passing through a transmit filter;
the random unitary precoding comprises: performing channel coding and digital modulation on an information bit sequence at a transmitter, performing unitary precoding on modulated information through a random unitary transformation matrix to obtain a new symbol sequence, and combining the new symbol sequence with a transmission scheme to obtain a transmission signal for transmission; and
the cross-domain iterative detection comprises using a cross-domain iterative receiver to receive the signal obtained after the random unitary coding modulation.

2. The signal transmission method based on random unitary coding modulation and cross-domain iterative detection according to claim 1, wherein the random unitary transformation matrix in the random unitary modulation is a unitary invariant matrix.

3. The signal transmission method based on random unitary coding modulation and cross-domain iterative detection according to claim 1, wherein a process of using the cross-domain iterative receiver is specifically as follows: based on a received signal y and priori estimation xₜ obtained through nonlinear detection, performing linear detection to output an estimated signal rₜ, performing inverse random unitary transformation to obtain a signal \tilde{r}ₜ, further, performing nonlinear detection to obtain an output estimated signal sₜ₊₁, performing random unitary transformation to generate xₜ₊₁ and input xₜ₊₁ into linear detection; conducting iteration until the estimated signal sₜ₊₁ is accurately recovered or a preset maximum iteration count is reached, ending the entire detection process, and outputting a final estimated signal as the received signal.

4. The signal transmission method based on random unitary coding modulation and cross-domain iterative detection according to claim 3, wherein the cross-domain iterative receiver is a Bayesian optimal cross-domain iterative receiver, and the Bayesian optimal cross-domain iterative receiver specifically multiplies a sparse time-domain channel matrix with an input signal using a time-domain memory matched filter (MF) in the linear detection of the cross-domain iterative receiver, and performs orthogonal minimum mean square error (MMSE) demodulation in the nonlinear detection.

5. The signal transmission method based on random unitary coding modulation and cross-domain iterative detection according to claim 1, wherein processing of the random unitary modulation at the transmitting end in a multiple-input multiple-output (MIMO) scenario comprises: performing signal segmentation after the random unitary modulation or performing signal segmentation before the random unitary modulation; and said performing signal segmentation before the random unitary modulation further comprises performing the segmentation using a random permutation matrix before the random unitary modulation; and
corresponding processing at the receiving end comprises: separately receiving signals through receive filters on antennas of the receiving end, removing CPs, and performing signal merging; after the signal merging, using the cross-domain iterative receiver to receive the signal obtained after the random unitary coding modulation.

6. The signal transmission method based on random unitary coding modulation and cross-domain iterative detection according to claim 5, wherein said performing signal segmentation after the random unitary modulation specifically comprises:
segmenting a digital modulation signal into a plurality of segments after the S/P conversion and the random unitary modulation, adding a CP to each segment, obtaining a time-domain signal through a transmit filter, and transmitting the time-domain signal to the channel through the antenna; and
corresponding processing by the cross-domain iterative receiver is as follows: based on a received signal y and priori estimation xₜ obtained through nonlinear detection, performing linear detection to output an estimated signal rₜ, performing inverse random unitary transformation to obtain a signal \tilde{r}ₜ, further, performing nonlinear detection to obtain an output estimated signal sₜ₊₁, performing random unitary transformation to generate xₜ₊₁ and input xₜ₊₁ into linear detection; conducting iteration until the estimated signal sₜ₊₁ is accurately recovered or a preset maximum iteration count is reached, ending the entire detection process, and outputting a final estimated signal as the received signal.

7. The signal transmission method based on random unitary coding modulation and cross-domain iterative detection according to claim 5, wherein said performing signal segmentation before the random unitary modulation specifically comprises:
segmenting a digital modulation signal into a plurality of segments after the S/P conversion, performing random unitary modulation on each segment and adding a CP to each segment, obtaining a time-domain signal through a transmit filter, and transmitting the time-domain signal to the channel through the antenna; and
corresponding processing at the receiving end is as follows: separately receiving signals through receive filters on antennas of the receiving end, removing CPs, and performing signal merging; after the signal merging, using the cross-domain iterative receiver to receive the signal obtained after the random unitary coding modulation, wherein implementation steps of the cross-domain iterative receiver comprise: segmenting an estimated signal rₜ output from linear detection into Nₜ segments, performing inverse random unitary modulation on each segment, merging the segments to obtain an estimated signal \tilde{r}ₜ, and inputting the estimated signal \tilde{r}ₜ into nonlinear detection; segmenting an estimated signal sₜ₊₁ output from nonlinear detection into Nₜ segments, performing random unitary modulation on each segment, merging the segments to obtain an estimated signal xₜ₊₁, and inputting the estimated signal xₜ₊₁ into linear detection; conducting iteration until the estimated signal sₜ₊₁ is accurately recovered or a preset maximum iteration count is reached, ending the entire detection process, and outputting a final estimated signal as the received signal.

8. The signal transmission method based on random unitary coding modulation and cross-domain iterative detection according to claim 5, wherein said performing the segmentation using a random permutation matrix before the random unitary modulation specifically comprises:
segmenting a digital modulation signal into a plurality of segments after the S/P conversion and the random permutation matrix, performing random unitary modulation on each segment and adding a CP to each segment, obtaining a time-domain signal through a transmit filter, and transmitting the time-domain signal to the channel through the antenna; and
corresponding processing at the receiving end is as follows: separately receiving signals through receive filters on antennas of the receiving end, removing CPs, and performing signal merging; after the signal merging, using the cross-domain iterative receiver to receive the signal obtained after the random unitary coding modulation, wherein implementation steps of the cross-domain iterative receiver comprise: segmenting an estimated signal rₜ output from linear detection into Nₜ segments, performing inverse random unitary modulation on each segment, merging the segments and inputting into the random permutation inverse matrix Π^{H} to obtain an estimated signal \tilde{r}ₜ, and inputting the estimated signal \tilde{r}ₜ into nonlinear detection; segmenting an estimated signal sₜ₊₁ output from nonlinear detection into Nₜ segments, inputting the segments into the random permutation matrix Π and segmenting into Nₜ segments, performing random unitary modulation on each segment, merging the segments to obtain an estimated signal xₜ₊₁, and inputting the estimated signal xₜ₊₁ into linear detection; conducting iteration until the estimated signal sₜ₊₁ is accurately recovered or a preset maximum iteration count is reached, ending the entire detection process, and outputting a final estimated signal as the received signal.

9. The signal transmission method based on random unitary coding modulation and cross-domain iterative detection according to claim 1, wherein the random unitary coding modulation using the random unitary precoding specifically comprises:
performing channel coding on the information bit sequence to generate a sequence c, mapping the sequence C into a symbol sequence s through digital modulation, precoding s using a random unitary matrix U to obtain a new symbol sequence b, that is, b=Us, generating a transmission sequence x using the existing transmission scheme P, wherein x=Pb=PUs, and transmitting the sequence x to the channel, wherein the signal y received at the receiving end is denoted as:
$$y = Hx + w = HPUs + w = {H}_{eff} s + w ,$$
H_{eff}=HPU, H is a time-domain channel matrix, H_{eff} is a transform domain equivalent channel, and w˜CN (0,σ²I) is an additive Gaussian white noise.
